(19) United States
(12) Patent Application Publication
(10) Pub. No.: US 2025/0206132 A1
(43) Pub. Date: Jun. 26, 2025

(54) IMAGING APPARATUS AND NON-TRANSITORY STORAGE MEDIUM

(71) Applicant: TOYOTA JIDOSHA KABUSHIKI KAISHA, Toyota-shi (JP)

(72) Inventor: Yoji ICHIKAWA, Nagoya-shi (JP)

(73) Assignee: TOYOTA JIDOSHA KABUSHIKI KAISHA, Toyota-shi (JP)

(21) Appl. No.: 18/973,427

(22) Filed: Dec. 9, 2024

(30) Foreign Application Priority Data
Dec. 26, 2023 (JP) 2023-219936

(51) Int. Cl. B60K 35/21; B60K 35/28; B60K 35/29; G06T 7/20; G06T 11/00; G06V 20/58; H04N 7/18

(52) U.S. Cl. CPC B60K 35/21; B60K 35/28; B60K 35/29; G06T 7/20; G06T 11/00; G06V 20/58; H04N 7/181; B60K 2360/191; G06T 2207/20092; G06T 2207/30261

(57) ABSTRACT

An imaging apparatus and a program capable of tracking and regenerate a monitoring target selected by a user are provided. An imaging device for performing display control of a captured image obtained by imaging an environment around a vehicle, wherein a processor mounted in the imaging device is configured to perform the following processing, recognizing a monitoring target included in the captured image, generating a processed captured image obtained by adding highlighting to the captured image to enhance the visibility of the monitoring target, displaying the processed captured image on a display unit, tracking the monitoring target to which the highlighting is added; and causing the display unit to display the monitoring target based on an input operation in which a user selects the monitoring target.

### FIELD

The present invention relates to an imaging apparatus and a non-transitory storage medium for tracking a monitoring target designated by a user.

### BACKGROUND

Patent Literature 1 (Japanese patent publication No.2020-145687) discloses an imaging apparatus that includes a first camera and a second camera capable of capturing an image of a range equal to or larger than a hemisphere and can capture an image of a range equal to or larger than an omnidirectional sphere. According to the imaging device described in Patent Literature 1, it is possible to acquire a captured image with a reduced blind spot.

### SUMMARY

As in the imaging apparatus described in Patent Literature 1, in case of a camera is added to reduce blind spots, captured images having different imaging directions also increase according to the number of cameras. Therefore, according to the technique described in Patent Literature 1, in case of a user reproduces a captured image in which an object to be monitored is captured, the user needs to select a specific captured image from a plurality of different captured images, and there is a possibility that the operation and the reproduction mode become complicated.

An object of the present invention is to provide an imaging apparatus and a program capable of tracking and regenerate a monitoring target selected by a user.

One aspect of the present invention is an imaging device for performing display control of a captured image obtained by imaging an environment around a vehicle, wherein a processor mounted in the imaging device is configured to perform the following processing, recognizing a monitoring target included in the captured image, generating a processed captured image obtained by adding highlighting to the captured image to enhance the visibility of the monitoring target, displaying the processed captured image on a display unit, tracking the monitoring target to which the highlighting is added; and causing the display unit to display the monitoring target based on an input operation in which a user selects the monitoring target.

According to the present invention, it is possible to track and reproduce a monitoring target selected by a user from the captured images captured by the imaging apparatus.

### BRIEF DESCRIPTION OF DRAWINGS

FIG. 1 is a block diagram showing a configuration of a vehicle system according to an embodiment.

FIG. 2 is a diagram showing an imaging range of an imaging device provided in a vehicle.

FIG. 3 is a diagram showing an example of a processed captured image obtained by adding highlighting to a monitoring target included in the captured image.

FIG. 4 is a diagram showing an example of a state in which a processed captured image obtained by tracking a monitoring target is displayed.

FIG. 5 is a flowchart showing a flow of processing of an imaging method executed in the imaging apparatus.

### DESCRIPTION OF EMBODIMENT

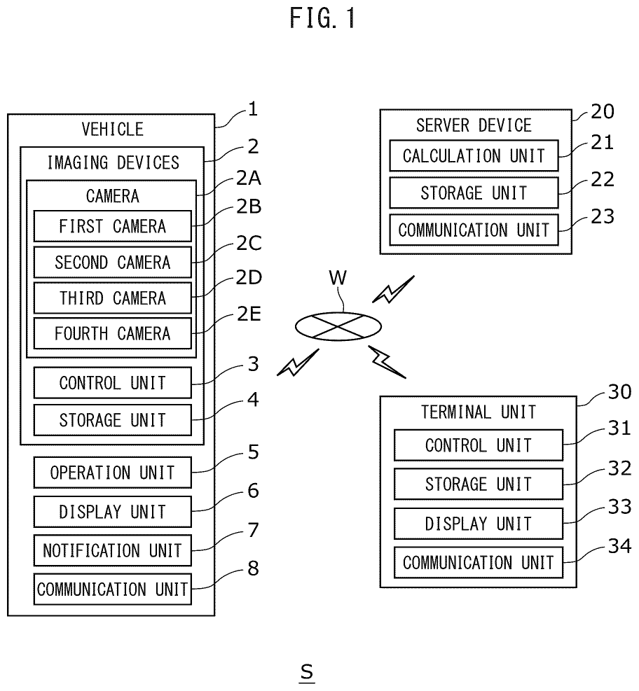

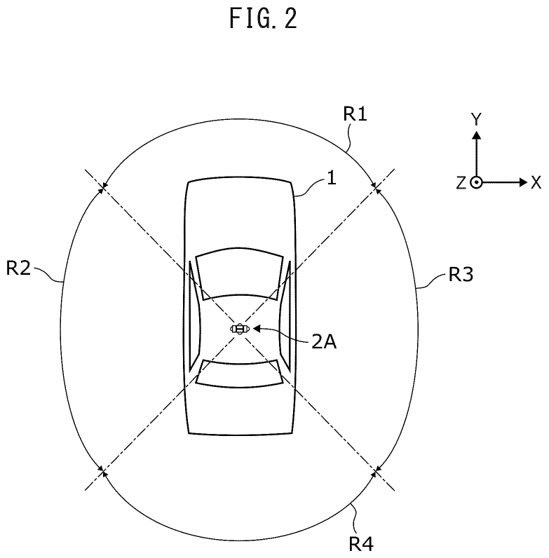

As shown in FIGS. 1 and 2, the vehicle system S includes a vehicle 1, a terminal device 30 possessed by a user, and a server device 20 that executes processing related to imaging, which are communicably connected to each other via a network W. The vehicle 1 is provided with an imaging device 2 capable of capturing an image of an environment around the vehicle. The vehicle 1 communicates with the server device 20 and mutually transmits and receives data and programs related to captured images captured by the imaging device 2. The vehicle 1 and the server device 20 execute processing related to the captured images based on an input operation input to the terminal device 30.

The vehicle 1 is, for example, a four-wheeled vehicle provided with the imaging device 2. The vehicle 1 may be a manual driving vehicle or an automatic driving vehicle. The vehicle 1 may be an automobile having two wheels other than four wheels, three wheels, and four or more wheels.

The imaging device 2 captures the captured image such as a moving image or a still image. The imaging device 2 functions as a drive recorder in case of the vehicle 1 is traveling. The imaging device 2 includes, for example, a camera 2A that captures an image of the environments of the vehicle 1 for each predetermined imaging area. The camera 2A includes a plurality of camera devices that capture images of the surroundings of the vehicles 1 at predetermined intervals. In each camera device, the imaging range is individually set so that a blind spot does not occur in the environment around the vehicle 1.

In the illustrated example, the camera 2A includes four camera devices. The camera 2A includes, for example, a first camera 2B that captures the first imaging area R1. The first camera 2B captures, for example, a first imaging range R1 having an angle of view of a predetermined angular range toward the traveling direction (the +Y direction in FIG. 2) of the vehicle 1.

The camera 2A includes, for example, a second camera 2C that captures the second imaging area R2. The second camera 2C captures, for example, a second imaging range R2 having an angle of view of a predetermined angular range toward the left side (FIG. 2: −X direction) as viewed in the traveling direction of the vehicle 1. The second imaging range R2 and the first imaging range R1 have overlapping angular ranges.

The camera 2A includes, for example, a third camera 2D that captures the third imaging area R3. For example, the third camera 2D captures a third imaging range R3 having an angle of view of a predetermined angular range toward the right side (FIG. 2: +X direction) as viewed in the traveling direction of the vehicle 1. The third imaging range R3 and the first imaging range R1 have overlapping angular ranges.

The camera 2A includes, for example, a fourth camera 2E that captures the fourth imaging area R4. The fourth camera 2E captures, for example, a fourth imaging range R4 having an angle of view of a predetermined angular range in a direction opposite to the traveling direction of the vehicle 1 (i.e., the —Y direction in FIG. 2). The fourth imaging range R4 and the second imaging range R2 have overlapping angular ranges. The fourth imaging range R4 and the third imaging range R3 have overlapping angular ranges.

The camera 2A may include not only a plurality of camera devices but also one omnidirectional camera having an imaging range of 360 degrees and two hemispherical cameras having an imaging range of 180 degrees. The camera 2A may be constituted by any camera device capable of reducing blind spots.

The first camera 2B, the second camera 2C, the third camera 2D, and the fourth camera 2E are controlled by the control unit 3 provided in the imaging device 2. The control unit 3 reads data and programs required for control from the storage unit 4 provided in the imaging device 2 and controls the camera 2A. The control unit 3 performs display control of imaging images captured by the camera 2A. The captured image is stored in the storage unit 4 based on a predetermined file format at predetermined time intervals.

The storage unit 4 stores captured images captured by the first camera 2B, the second camera 2C, the third camera 2D, and the fourth camera 2E for a predetermined period. In case of there is no event in the environment around the vehicle 1, the imaging images are discarded from the storage unit 4 at predetermined timings in chronological order and are always stored in the storage unit 4 in the newest order. In case of an event exists in the environment around the vehicle 1, the captured image is stored in the storage unit 4 retroactively for a predetermined time.

The control unit 3 is constituted by a hardware processor such as at least one CPU (Central Processing Unit). The storage unit 4 is constituted by a non-transitory storage medium such as a hard disk drive (HDD) or a solid-state disk (SSD).

The vehicle 1 is provided with an operation unit 5 for receiving an input operation of the user with respect to the imaging device 2. The operation unit 5 includes an input interface such as a physical button and a jog dial. The user operates the operation unit 5 to operate the imaging apparatus 2. The vehicle 1 is provided with a display unit 6 that displays the captured image captured by the imaging device 2.

The display unit 6 is constituted by a display device capable of displaying an image such as a liquid crystal display. In case of the display unit 6 is constituted by a touch panel, it may be integrated with the operation unit 5 by displaying an input display image for receiving an input operation of a user. The operation unit 5 and the display unit 6 may be configured by the terminal device 30 carried by the user.

The vehicle 1 is provided with a notification unit 7 that outputs a predetermined notification inside or outside the vehicle. The notification unit 7 includes a speaker for audio output, an electro-optical bulletin device for outputting characters and images, a light-emitting device for outputting light based on a predetermined output pattern, and the like. The vehicle 1 is provided with a communication unit 8 that can be communicatively connected to the network W. The communication unit 8 is a communication interface for communicating with the server device 20 and the terminal device 30 via the network W. The communication unit 8 includes, for example, a communication interface capable of mobile communication, and a radio interface such as wi-fi (registered trademark) or Bluetooth (registered trademark).

The server device 20 communicates with the vehicle 1 via the network W and acquires the captured image. The server device 20 includes a calculation unit 21 that executes predetermined processing on the captured image. The server device 20 includes a storage unit 22 that stores data and programs necessary for processing of the calculation unit 21. The server device 20 includes a communication unit 23 configured by a communication interface capable of communicating via a network W. The calculation unit 21 includes at least one hardware processor such as a CPU.

The storage unit 22 is constituted by a non-transitory storage medium such as a hard disk drive or a solid-state disk. The communication unit 23 includes, for example, a wireless interface or a wired interface that can be connected to the network W.

The terminal device 30 is, for example, an information processing terminal device capable of wireless communication such as a smartphone, a personal computer, or a tablet terminal device. The terminal device 30 receives an input operation related to the imaging device 2 via the network W or by directly communicating with the vehicle 1. The terminal device 30 acquires and displays the captured image by communicating with the vehicle 1.

The terminal device 30 includes a control unit 31 that executes processing necessary for an input operation and display of the captured image. The terminal device 30 includes a storage unit 32 that stores data and programs necessary for processing by the control unit 31. The control unit 31 includes at least one hardware processor such as a CPU. The storage unit 32 is constituted by a non-transitory storage medium such as a hard disk drive or a solid-state disk.

The terminal device 30 includes a display unit 33 that receives an input operation and displays a display image. The display unit 33 is constituted by, for example, a touch panel type liquid crystal display. The communication unit 34 includes, for example, a communication interface capable of mobile communication, and a radio interface such as wi-fi (registered trademark) or Bluetooth (registered trademark).

With the above configuration, the imaging device 2 detects a monitoring target that may affect the vehicle 1 based on the captured image obtained by capturing an image of the environment around the vehicle 1. The monitoring target includes, for example, a person approaching within a predetermined distance range of the vehicle 1, an animal, a vehicle, a moving object such as a drone, and the like. For example, in case of the vehicle 1 is stopped, the imaging device 2 operates as a monitoring camera that captures an image of the environment around the vehicle 1.

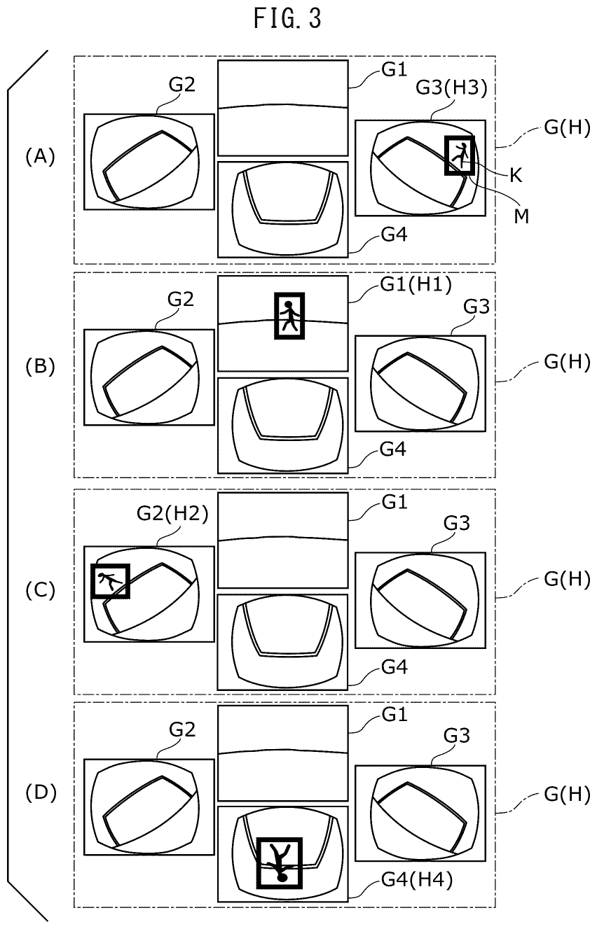

As shown in FIG. 3, in case of the vehicle 1 is parked, the control unit 3 acquires the captured image G captured by the imaging device 2. The captured image G includes a plurality of divided captured images captured by the imaging device 2 for each imaging range. The control unit 3 acquires, for example, a captured image G including a first divided captured image G1 captured by the first camera 2B. The control unit 3 acquires a second divided captured image G2 captured by the second camera 2C. The control unit 3 acquires a third divided captured image G3 captured by the third camera 2D. The control unit 3 acquires a fourth divided captured image G4 captured by the fourth camera 2E. The control unit 3 combines the plurality of divided captured images to generate the captured image G.

The control unit 3 recognizes the monitoring target K included in the captured image G. The control unit 3 is set to be able to extract the monitoring target K included in the captured image G by executing machine learning using deep learning based on teacher data in advance. In case of the monitoring target K is recognized, the control unit 3 determines that an event has occurred in the environment around the vehicle 1, stores the captured image in the storage unit 4 from the imaging start time which has been traced back for a predetermined time, and prevents the captured image from being erased.

The control unit 3 causes the storage unit 4 to continue storing the captured image until the monitoring target K is no longer recognized. The control unit 3 extracts the monitoring target K, generates a processed captured image (H) in which the highlighting M that enhances the visibility of the monitoring target K is added to the captured image G, and stores the processed captured image (H) in the storage unit 4.

In the embodiment shown in FIG. 3A, the monitoring target K appears in the third divided captured image G3 obtained by capturing the third captured area R3 on the right side of the vehicle 1. The control unit 3 extracts the monitoring target K appearing in the third divided captured image G3 and generates a third processed divided captured image (H3) to which the highlighting M is added. In the illustrated example, the highlighting M is generated in a frame shape surrounding the monitoring target K. The highlighting M may be generated by appropriately combining not only a frame-shaped display but also a color, an arrow, character information, a line drawing, a blinking display, and the like if the visibility of the monitoring target K can be enhanced.

The control unit 3 moves the highlighting M in accordance with the movement of the monitoring target K. In case of the monitoring target moves from one divided captured image to another divided captured image while the divided captured image is being displayed on the display unit, the control unit 3 generates another divided captured image to which the highlighting M is added and stores the divide other divided captured image in the storage unit 4. In case of the monitoring target K moves from one divided captured image to another divided captured image, the control unit 3 generates another divided captured image in which the highlighting M is added. In the embodiment shown in FIG. 3B, the control unit 3 extracts the monitoring target K appearing in the first divided captured image G1 from the third divided captured image G3 and generates a first processed divided captured image (H1) to which the highlighting M is added.

In the embodiment shown in FIG. 3C, the control unit 3 extracts the monitoring target K appearing in the second divided captured image G2 from the first divided captured image G1 and generates a second processed divided captured image (H2) to which the highlighting M is added. In the embodiment shown in FIG. 3D, the control unit 3 extracts the monitoring target K appearing in the second divided captured image G2 from the first divided captured image G1 and generates a second processed divided captured image (H2) to which the highlighting M is added.

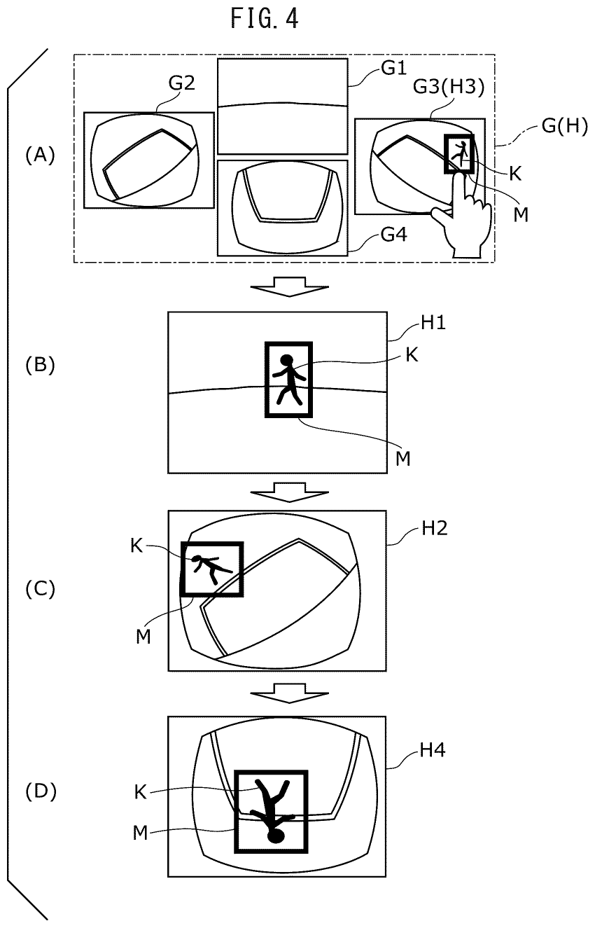

As shown in FIG. 4, the control unit 3 causes the display unit 6 to display the captured image G based on an input operation of the user. In case of the monitoring target K is included in the captured image G, the control unit 3 causes the display unit 6 to display the processed captured image H including the monitoring target K to which the highlighting M is added (see FIG. 4A). In case of the user confirms the processed captured image H and continuously displays the monitoring target K, the user performs an input operation of selecting the monitoring target K. The user performs an input operation of selecting the monitoring target K included in the processed captured image H by operating the operation unit 5. The user may perform an input operation of selecting the monitoring target K included in the processed captured image H by touching the display unit 6 constituted by the touch panel.

The control unit 3 selects one divided captured image in which the monitoring target K is captured from among the plurality of divided captured images based on the input operation and causes the display unit 6 to display the selected divided captured image. Based on the input operation, the control unit 3 selects, from among the plurality of divided captured images, a processed divided captured image in which the highlighting M is added to one divided captured image in which the monitoring target K is captured and causes the display unit 6 to display the processed divided captured image. The control unit 3 enlarges the processed divided captured image or displays the processed divided captured image on the display unit 6 in the form of a full screen.

The control unit 3 tracks the monitoring target K based on an input operation of the user, enlarges the divide divided captured image to which the highlighting M is added, and causes the display unit 6 to display the processed divided captured image. In FIG. 4, the control unit 3 selects the third processed divided captured image H3 from the processed captured image H based on the input operation (see FIG. 4A). In case of the monitoring target K moves, the control unit 3 tracks the monitoring target K and causes the display unit 6 to display the processed divided captured image (see FIGS. 4B to 4D).

The control unit 3 may calculate the physical feature amount for individually identifying the monitoring target K selected by the user, the feature amount of the motion, the feature amount of the behavior pattern such as the position and the time zone and store the calculated feature amount in the storage unit 4. In case of recognizing that the monitoring target K has an influence on the vehicle 1, the control unit 3 may generate a predetermined notification and cause the notification unit 7 to output the predetermined notification and may transmit the predetermined notification to the terminal device 30.

The control unit 3 may automatically track the monitoring target K and display the monitoring target K on the display unit 6 in case of the monitoring target K tracked in the past based on the past input operation is captured in the captured image G again based on the respective feature amounts. The control unit 3 may cause the display unit 6 to display information indicating that the monitoring target K has been recognized in the past. In case of the monitoring target K tracked in the past is captured in the captured image G again at the time of capturing the captured image G, the control unit 3 may generate a predetermined notification and transmit the notification to the terminal device 30.

In case of confirming the notification, the user may cause the notification unit 7 of the vehicle 1 to output a predetermined notification by performing an input operation of the terminal device 30. In case of the monitoring target K tracked in the past is captured in the captured image G again, the control unit 3 may cause the notification unit 7 to automatically output a predetermined notification.

The control unit 3 may transmit the calculated feature amount of the monitoring target K to the server device 20. The server device 20 may classify the monitoring target K based on data aggregated from the plurality of vehicles 1 and provide information to the plurality of vehicles 1 and the plurality of terminal devices 30. The control unit 3 may automatically recognize the monitoring target K based on the feature amount that has received the information provision, automatically generate, and store a processed captured image, and transmit a predetermined notification to the terminal device 30 or the server device 20. The control unit 3 may generate a processed captured image by adding character information related to the monitoring target K. In case of the monitoring target K is notified from the vehicle 1, the server device 20 may notify the terminal device 30 owned by the vehicle 1 or the user of the vehicle 1 of the predetermined range from the current position of the monitoring target K of the predetermined notification.

The server device 20 may generate the feature amount of the monitoring target K based on the information of the monitoring target K provided from the security authority such as the police and the information of the monitoring target K existing in the network W, and, in case of the monitoring target K is notified from the vehicle 1, notify the terminal device 30 owned by the user of the vehicle 1 or the vehicle 1 existing within a predetermined range from the current position of the monitoring target K. In case of confirming the notification, the user may notify the security authority by performing an input operation of the terminal device 30.

In case of the monitoring target K is notified from the vehicle 1, the server device 20 may automatically notify the security authority of a predetermined notification including the position information of the vehicle 1. Based on the notification received in real time, the security authority may dispatch a resource for executing the countermeasure in accordance with the content of the action of the monitoring target K to the area including the position of the vehicle 1 in which the monitoring target K is recognized.

The server device 20 may analyze the behavior pattern of the monitoring target K based on the aggregated data of the monitoring target K, calculate an estimated area in which the monitoring target K appears and appears and a time zone thereof, and transmit a predetermined notification to the terminal device 30 and the security authority of the user of the vehicle 1 included in the estimated region. Each process in the control unit 3 described above may be executed in cooperation with the calculation unit 21 of the server device 20 and the control unit 31 of the terminal device 30.

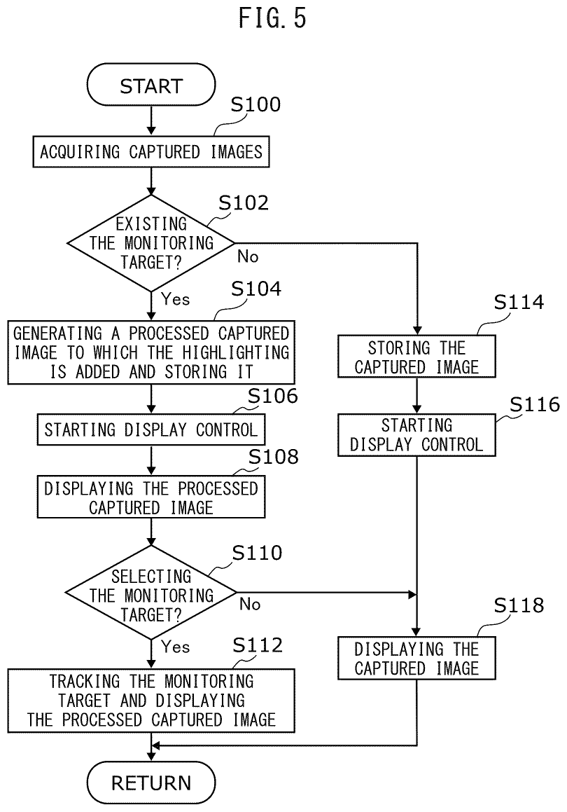

FIG. 5 shows a flow of processing of an imaging method executed in the imaging apparatus 2. The imaging method is executed based on a computer program installed in a computer installed in the imaging apparatus 2. The control unit 3 acquires captured images G obtained by capturing images of the environments of the vehicles 1 using the camera 2A (S100). The control unit 3 determines whether the captured image G includes the monitoring target K (S102). In case of the monitoring target K is included in the captured image G, the control unit 3 generates a processed captured image H to which the highlighting M is added and causes the storage unit 4 to store the processed captured image H (S104).

The control unit 3 starts displaying control based on the user's operation (S106). The control unit 3 causes the display unit 6 to display the processed captured image H (S108). The control unit 3 determines whether an inputting operation by the user to select the monitoring target K to which the highlighting M is added has been performed (S110). In case of the user selects the monitoring target K to which the highlighting M is added, the control unit 3 tracks the monitoring target K and causes the display unit 6 to display the monitoring target K (S112).

In case of the monitoring target K does not exist in the S102, the control unit 3 causes the storage unit 4 to store the captured image G (S114). The control unit 3 starts displaying control based on the user's operation (S116). The control unit 3 causes the display unit 6 to display the captured image G (S118). The control unit 3 causes the display unit 6 to display the captured image G in case of the user does not perform an input operation of selecting the monitoring target K to which the highlighted display M is added in the S110 (S118).

As described above, according to the imaging device 2, in case of the monitoring target K is recognized in the captured image G, it is possible to generate the processed captured image H in which the highlighting M is added to the monitoring target K. According to the imaging device 2, in case of the user performs an input operation of selecting the monitoring target K in case of the processed captured image H is displayed on the display unit 6, it is possible to display the processed captured image obtained by tracking the monitoring target K on the display unit 6.

In the above-described embodiment, the computer program executed in each configuration of the vehicle system S may be provided in a form recorded on a computer-readable portable non-transitory recording medium such as a semiconductor memory, a magnetic recording medium, or an optical recording medium. The computer program may be provided as a computer product that executes the processing described in the embodiment.

1. An imaging device for performing display control of a captured image obtained by imaging an environment around a vehicle, wherein a processor mounted in the imaging device is configured to perform the following processing:
recognizing a monitoring target included in the captured image;
generating a processed captured image obtained by adding highlighting to the captured image to enhance the visibility of the monitoring target;
displaying the processed captured image on a display unit;
tracking the monitoring target to which the highlighting is added; and
causing the display unit to display the monitoring target based on an input operation in which a user selects the monitoring target.

2. The imaging device according to claim 1, the processor is configured to perform the following processing:
obtaining one divided captured image in which the monitoring target is captured among a plurality of divided captured images which divide the environment into predetermined ranges,
generating a processed divided captured image by adding the highlighting to the divided captured image,
based on the input operation, selecting the processed divided captured image, and
causing the display unit to display the processed divided captured image.

3. The imaging device of claim 2, wherein the processor is configured to perform the following processing:
if the divided captured image on the display unit, in case of the monitoring target moves from one divided captured image to another divided captured image, causing the display unit to display another of the divided captured image.

4. The imaging device of claim 2, wherein the processor is configured to perform the following processing:
in case of capturing the monitoring target which is tracked in the past in the captured images again, tracking the monitoring target automatically; and
causing the display unit to display the monitoring target.

5. A non-transitory storage medium storing a computer program installed in a computer that performs display control of a captured image obtained by imaging an environment around a vehicle, wherein the non-transitory storage medium is configured to cause the computer to execute the following processing:
acquiring the captured image;
recognizing a monitoring target included in the captured image;
generating a processed captured image obtained by adding highlighting to the captured image to enhance the visibility of the monitoring target;
displaying the processed captured image on a display unit;
tracking the monitoring target to which the highlighting is added; and
causing the display unit to display the monitoring target based on an input operation in which a user selects the monitoring target.
